(19) United States
(12) Patent Application Publication
(10) Pub. No.: US 2025/0078582 A1
(43) Pub. Date: Mar. 6, 2025

(54) INCIDENT EVALUATION SYSTEM

(71) Applicant: GM Global Technology Operations LLC, Detroit, MI (US)

(72) Inventors: Matthew Edward Gilbert-Eyres, Rochester Hills, MI (US); Kevin W. Owens, Sterling Heights, MI (US); James Doherty, Detroit, MI (US); Benjamin Tran, Royal Oak, MI (US)

(73) Assignee: GM Global Technology Operations LLC, Detroit, MI (US)

(21) Appl. No.: 18/459,345

(22) Filed: Aug. 31, 2023

(51) Int. Cl. G07C 5/00; G06Q 40/08; G06V 20/59

(52) U.S. Cl. CPC G07C 5/008; G06Q 40/08; G06V 20/59

(57) ABSTRACT

An incident evaluation system for vehicle incidents includes a first imager configured to capture image data corresponding to a first vehicle and a first vehicle processor that is communicatively coupled to the first imager and configured to receive the captured image data. The first vehicle processor is configured to generate a first vehicle report in response to an incident captured in the image data and includes a first vehicle profile including at least one of first vehicle insurance details, driver details, and pre-incident image data. The incident evaluation system also includes a server communicatively coupled to the first vehicle processor and configured to receive the first vehicle report. The server is configured to evaluate the captured image data to generate an incident report.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to an incident evaluation system.

Vehicles often travel along road systems alongside or near other vehicles. Traffic and weather patterns may affect the driving pattern of some vehicles, such that a sudden delay in the flow of traffic may result in sudden breaking. In some instances, vehicles may collide as a result of a sudden change in driving patterns. In common practice, the drivers of the vehicles direct the respective vehicles to a safe stopping point and exit the vehicles to exchange information. Often, the drivers contact police personnel for support and observation of the post-collision events.

Post-collision, the drivers may have elevated tension levels and may forget to acquire certain documents that may be useful for insurance purposes. Additionally, the drivers may disagree as to the at-fault party and face-to-face interaction may cause increased tension. In other instances, the collision event may result in a situation where the driver or other occupants may seek medical assistance, such that exiting the vehicle may prove difficult. Typically, police personnel interview surrounding witnesses in preparing a police report. However, often witnesses leave the scene of the collision event before an interview may take place.

### SUMMARY

In some aspects, a vehicle incident evaluation system includes at least one imager configured to capture image data and a first vehicle processor that stores a first vehicle profile and is configured to receive captured image data of a first vehicle from the imager. The first vehicle processor is configured to generate a first vehicle report including the first vehicle profile and the captured image data in response to an impact event. A second vehicle processor stores a second vehicle profile and is configured to generate a second vehicle report that includes the second vehicle profile in response to the impact event. A server is communicatively coupled to each of the first vehicle processor and the second vehicle processor and includes a server processor that is configured to receive each of the first vehicle report and the second vehicle report. The server processor is configured to generate an incident report and determine an impact direction based on comparison of the first vehicle report and the second vehicle report.

In some examples, the at least one imager may include a first imager coupled to the first vehicle and a second imager coupled to a second vehicle. The first vehicle processor may be configured to receive image data from the first imager and the second vehicle processor may be configured to receive image data from the second imager. The server processor may be configured to compare the image data from the first imager with the image data from the second imager to determine the impact direction. Optionally, the first vehicle profile may include first vehicle insurance details and the second vehicle profile includes second vehicle insurance details. The server processor may be configured to receive the first vehicle insurance details and the second vehicle insurance details and may be configured to exchange the first vehicle insurance details with a driver of a second vehicle via the second vehicle processor and exchange the second vehicle insurance details with a driver of the first vehicle via the first vehicle processor. In other examples, the at least one imager may be disposed within an interior cabin of one of the first vehicle and a second vehicle. The first vehicle processor and the second vehicle processor may each be configured to gather data from one or more user devices within an interior cabin of the first vehicle and an interior cabin of a second vehicle, respectively.

In another aspect, an incident evaluation system for vehicle incidents includes a first imager configured to capture image data corresponding to a first vehicle and a first vehicle processor that is communicatively coupled to the first imager and configured to receive the captured image data. The first vehicle processor is configured to generate a first vehicle report in response to an incident captured in the image data and includes a first vehicle profile including at least one of first vehicle insurance details, driver details, and pre-incident image data. The incident evaluation system also includes a server communicatively coupled to the first vehicle processor and configured to receive the first vehicle report. The server is configured to evaluate the captured image data to generate an incident report.

In some configurations, the incident evaluation system may also include a second vehicle processor that may be communicatively coupled to the server and may include a second vehicle profile. The second vehicle processor may be configured to generate a second vehicle report in response to the incident. A second imager is configured to capture image data corresponding to a second vehicle. The server is configured to compare the image data from the second vehicle processor with the image data from the first vehicle processor to identify an impact direction. The server may be configured to query third party devices for third party data related to the incident. In further examples, the server may be configured to compare the third party data with the first vehicle report and the second vehicle report to determine an impact direction. The server may be configured to receive a plurality of impact reports in addition to the first vehicle report and may be configured to identify involved parties for each respective impact report including the first vehicle report. Optionally, the server may include an incident log configured to store the incident report and track future incident reports corresponding to vehicle profiles including the first vehicle profile.

In yet another aspect, an incident evaluation system includes a first vehicle processor that stores a first vehicle profile including first vehicle insurance details and is configured to gather first vehicle impact data in response to a first impact event. The first vehicle processor is also configured to generate a first vehicle report including the first vehicle profile and the first vehicle impact data in response to the first impact event. A second vehicle processor stores a second vehicle profile and is configured to generate a second vehicle report including the second vehicle profile in response to the first impact event or a second impact event different than the first impact event. A server is communicatively coupled to each of the first vehicle processor and the second vehicle processor and is configured to receive each of the first vehicle report and the second vehicle report. The server is configured to generate an incident report and determine an impact direction based on comparison of the first vehicle report and the second vehicle report.

In some examples, the first vehicle impact data may include image data from a first imager coupled to one of a forward portion and a rearward portion of a first vehicle. The second vehicle processor may be configured to gather second vehicle impact data from a second imager coupled to one of a forward portion and a rearward portion of a second vehicle. The server may be configured to compare the first vehicle impact data with the second vehicle impact data to determine the impact direction. The server may be configured to determine whether the first vehicle report and the second vehicle report include the first impact event. Optionally, the server may be configured to query third party devices for third party data related to the impact event.

### BRIEF DESCRIPTION OF THE DRAWINGS

The drawings described herein are for illustrative purposes only of selected configurations and are not intended to limit the scope of the present disclosure.

FIG. 1 is a schematic diagram of an incident involving a first vehicle and a second vehicle;

FIG. 2 is a schematic diagram of an incident involving a first vehicle and a second vehicle in communication with a server and a third party device according to the present disclosure;

FIG. 3 is a functional block diagram of an example incident evaluation system according to the present disclosure;

FIG. 4 is an enlarged partial perspective view of an interior cabin of a vehicle according to the present disclosure with a driver and a passenger;

FIG. 5 is a functional block diagram of an example incident evaluation system according to the present disclosure;

FIG. 6 is an example flow diagram for an incident evaluation system according to the present disclosure; and

FIG. 7 is an example flow diagram for an incident evaluation system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including.” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first.” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below; the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

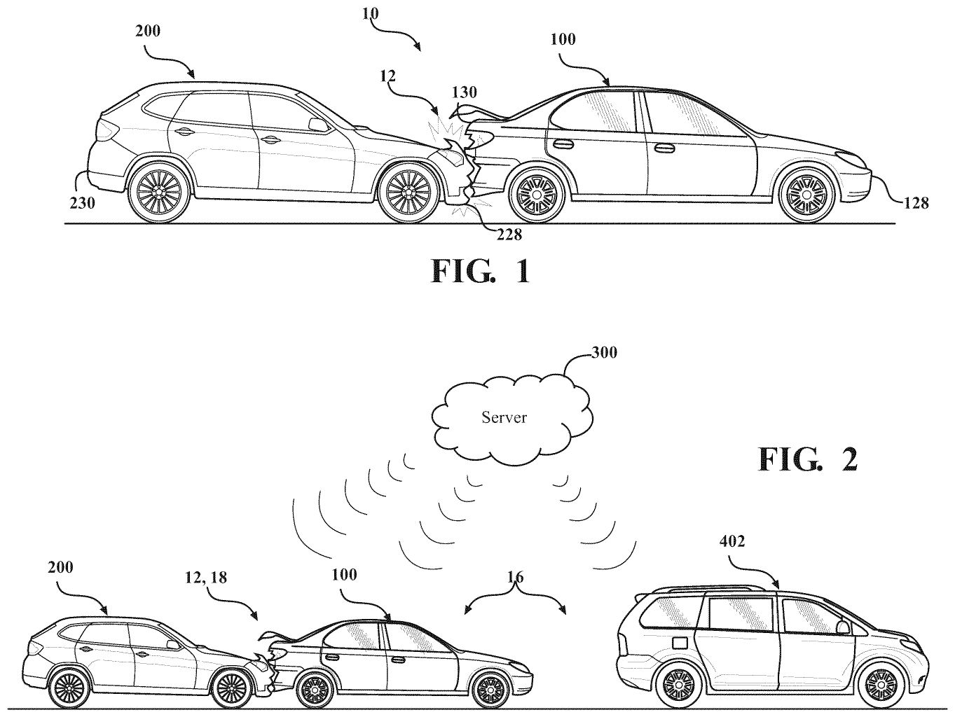

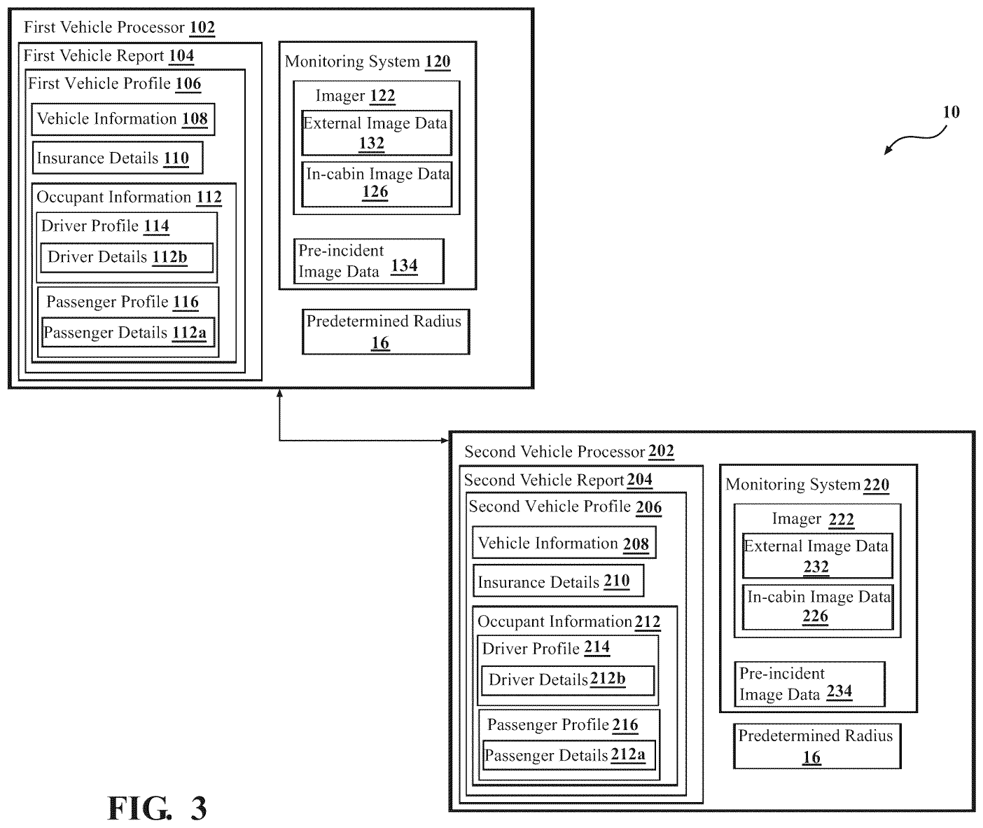

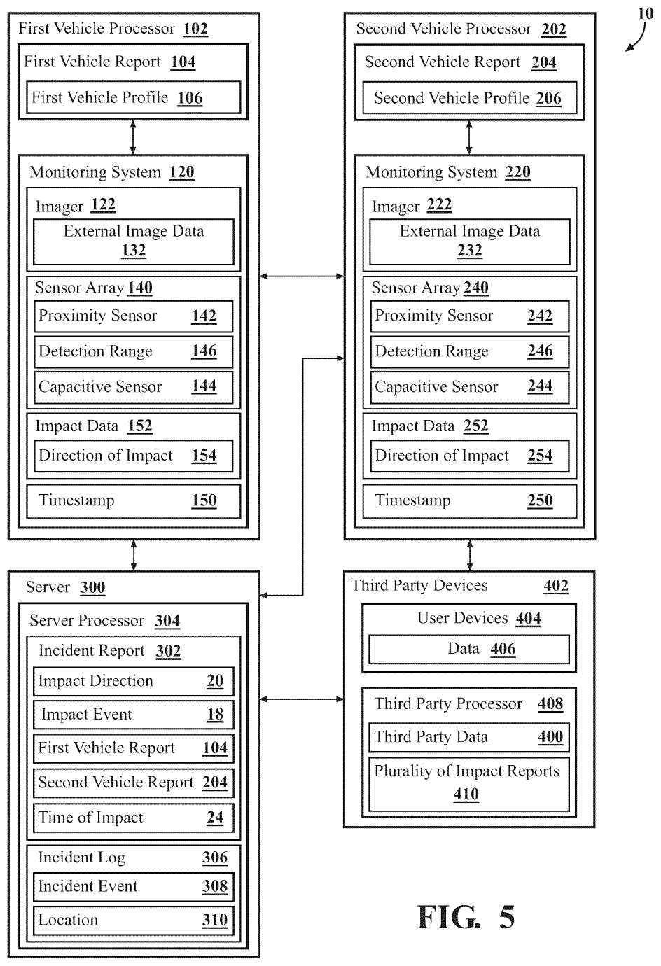

Referring to FIGS. 1-7, an incident evaluation system 10 is configured to receive data regarding an incident 12 between one or more vehicles. For example, a first vehicle 100 and a second vehicle 200 are illustrated in FIG. 1 with the incident 12 depicted as a rear-end impact. Each of the first vehicle 100 and the second vehicle 200 is equipped with a vehicle processor 102, 202, each of which respectively is configured to generate a vehicle report 104, 204 in response to the incident 12. Each of the vehicle reports 104, 204 is communicated to a server 300 to ultimately generate an incident report 302 for an insurance company and police personnel. While the description herein is generally directed to an incident 12 involving the first vehicle 100 and the second vehicle 200, it is contemplated that the incident 12 may involve more than two vehicles. Additionally or alternatively, the incident 12 may involve a single vehicle and a non-vehicle object. The incident evaluation system 10 may collectively define the vehicle processors 102, 202 and the server 300 that collectively cooperate to generate the incident report 302. It is also contemplated that the incident evaluation system 10 may also receive third party data 400 that may be captured or otherwise collected by one or more third party devices 402 that are independent of the incident 10, described in further detail below.

With specific reference to FIGS. 1-4, the first vehicle 100 and the second vehicle 200 are each equipped with the respective vehicle processor 102, 202. Each vehicle processor 102, 202 includes a vehicle profile 106, 206, which includes vehicle information 108, 208. The vehicle information 108, 208 may include, but is not limited to, a model year, a make, a color, and a trim of the respective vehicle 100, 200. The vehicle profile 106, 206 also includes insurance details 110, 210 and occupant information 112, 212 for one or more occupants 14 of the vehicle 100, 200. The vehicle profile 106, 206 may be manually input and updated by an owner-occupant 14 of the vehicle 100, 200. In some aspects, the vehicle processor 102, 202 may query occupant information 112, 212 from user devices 404 within the respective vehicle 100, 200.

For example, occupant information 112, 212 stored in the vehicle profile 106, 206 may also include passenger details 112a, 212a and driver details 112b, 212b. The passenger details 112a, 212a may be queried from the user devices 404 within the vehicle 100, 200. The driver details 112b, 212b may also be queried from the user device 404 of a driver 14a. Additionally or alternatively, the driver 14a may manually input the driver details 112b, 212b. In some examples, the driver 14a may have a pre-programmed driver profile 114, 214 in which the driver details 112b, 212b may be stored. Given the likelihood that passengers 14b of the vehicle 100, 200 may vary as compared to the driver 14a, the vehicle processor 102, 202 may query for the passenger details 112a, 212a. However, in some examples, the vehicle processor 102, 202 may include one or more passenger profiles 116, 216 as part of the occupant information 112, 212. The occupant information 112, 212 may include identifying information, such as a name, height, and eye color of the occupants. In some examples, the occupant information 112, 212 may include a license associated with each respective occupant, with the license of the driver 14a stored in the driver profile 114, 214.

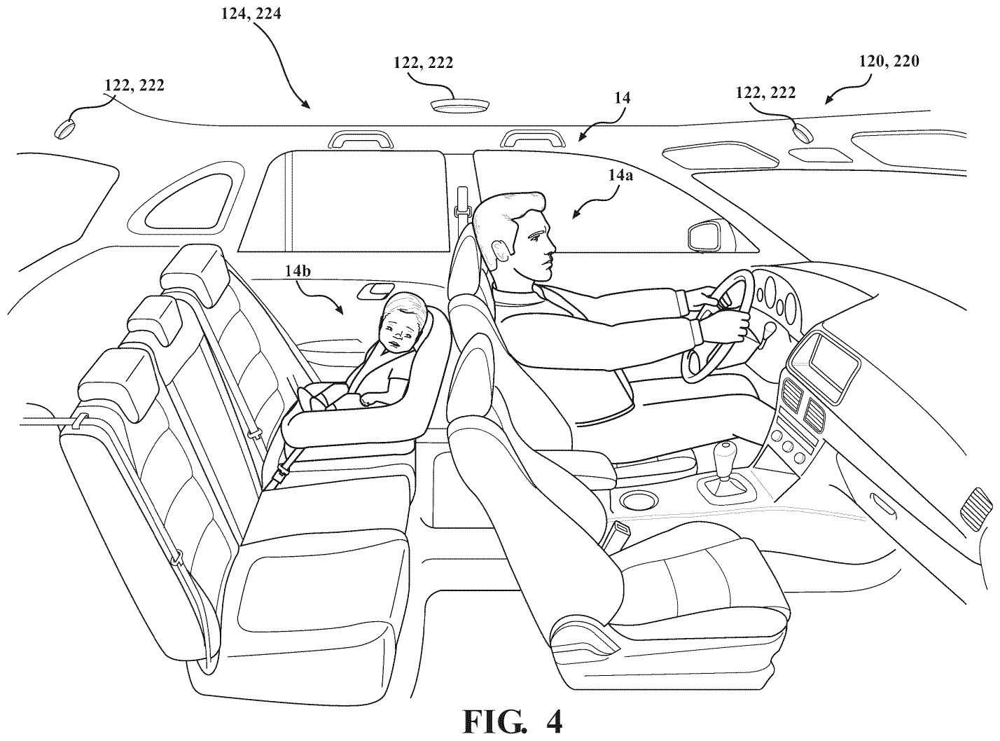

Each vehicle 100, 200 may also include a monitoring system 120, 220 that is in communication with the vehicle processor 102, 202. The monitoring system 120, 220 may include at least one imager 122, 222 disposed within an interior cabin 124, 224 of the vehicle 100, 200. As depicted in FIG. 4, a plurality of imagers 122, 222 are disposed within the interior cabin 124, 224. Further, the at least one imager 122, 222 may be used to collectively refer to and include a first imager 122 of the first vehicle 100 and a second imager 222 of the second vehicle 200. The imagers 122, 222 may be disposed within the interior cabin 124, 224 of the vehicle 100, 200 to capture in-cabin image data 126, 226. The image data 126, 226 may include a position of the occupants 14 within the vehicle 100, 200. For example, the imager 122, 222 may capture the position of a driver 14a within the vehicle 100, 200 and any passengers 14b.

The vehicle processor 102, 202 may match the in-cabin image data 126, 226 with the driver details 112, 212. The vehicle processor 102, 202 may identify whether the in-cabin image data 126, 226 of the driver 14a corresponds with the driver details 112, 212 stored in the vehicle processor 102, 202. In some examples, the vehicle processor 102, 202 may include in the vehicle report 104, 204 any detected inconsistencies between the in-cabin image data 126, 226 and the driver details 112, 212. The vehicle processor 102, 202 may also utilize the in-cabin image data 126, 226 to assess a possible in-cabin event that may be related to or have preceded the incident 12. If the vehicle processor 102, 202 determines that an in-cabin event may be related to the incident 12, the vehicle processor 102, 202 may include the in-cabin event in the vehicle report 104, 204.

The imager 122, 222 may additionally or alternatively be disposed external to the vehicle 100, 200 at a forward portion 128, 228 and/or a rearward portion 130, 230 of the vehicle 100, 200. The imagers 122, 222 external to the vehicle 100, 200 are configured to capture external image data 132, 232. It is contemplated that the external image data 132, 232 may include video data. The video data may be gathered during operation of the vehicle 100, 200 and/or when the vehicle 100, 200 is stationary or otherwise not in current operation. For example, the external imager 122, 222 may capture the external image data 132, 232 when the vehicle 100, 200 is turned off or otherwise idle. In addition, the external imager 122, 222 may assist in capturing surrounding traffic patterns including potential incidents that may or may not involve the vehicle 100, 200.

With further reference to FIGS. 1-4, the imagers 122, 222 within the interior cabin 124, 224 are configured to capture pre-incident image data 134, 234, which may be incorporated as part of the vehicle profile 106, 206. The pre-incident image data 134, 234 may also include exterior images of the vehicle 100, 200, which may be uploaded or otherwise provided by an owner of the vehicle 100, 200 as a reference point of the vehicle 100, 200 prior to the incident 12. The pre-incident image data 134, 234 may be used by the server 300 in assessing the incident 12, as described below, any may include any potential damage to the vehicle 100, 200.

In some examples, the vehicle processors 102, 202 may communicate with nearby vehicle processors to exchange the vehicle profiles 106, 206 in response to the incident 12. For example, the first vehicle processor 102 may send the first vehicle profile 106 to the second vehicle processor 202 in response to the incident 12. In some examples, the vehicle processors 102, 202 may query all vehicles within a predetermined radius 16 of the incident 12. The predetermined radius 16 may be stored in the vehicle processor 102, 202 and may be defined around a perimeter of the vehicle 100, 200. It is contemplated that, while the predetermined radius 16 captures nearby vehicles, the predetermined radius 16 is designed to minimize the number of vehicle profiles evaluated by the vehicle processor 102, 202 to assist in detecting the vehicle(s) involved in the incident 12.

As mentioned above, the vehicle processor 102, 202 may also query the user devices 404 within the interior cabin 124, 224 of the vehicle 100, 200. For example, the user devices 404 may have captured image data related to the incident 12 and/or may provide the vehicle processor 102, 202 with context of the occupant behavior before, during, and/or after the incident 12. Data 406 gathered from the user devices 404 may be compiled along with the pre-incident image data 134, 234 and the vehicle profile 106, 206 as part of the vehicle report 104, 204 generated by the vehicle processor 102, 202.

With further reference to FIGS. 1-4, the monitoring system 120 may also include a sensor array 140, 240 that includes at least one of a proximity sensor 142, 242 and a capacitive sensor 144, 244. The proximity sensor 142, 242 is configured to detect objects, such as surrounding vehicles that are nearby or approaching the vehicle 100, 200. It is contemplated that the proximity sensor 142, 242 is configured with a detection range 146, 246, such that the proximity sensor 142, 242 records proximity data when the object (i.e., vehicle) is within the detection range 146, 246.

The capacitive sensor 144, 244 is configured to detect contact between the vehicle 100, 200 and an object. The illustrated example of FIG. 1 depicts an impact event 18 between the first vehicle 100 and the second vehicle 200. One or both of the vehicles 100, 200 may be equipped with the capacitive sensor 144, 244 to detect the impact event 18. It is contemplated that the vehicle processor 102, 202 may log a timestamp 150, 250 associated with the impact event 18 detected by the capacitive sensor 144, 244. The data corresponding to the impact event 18 collected by the vehicle processor 102, 202 from the sensor array 140, 240 may be referred to as impact data 152, 252.

With reference to FIGS. 2-5, the vehicle processor 102, 202 is configured to generate the vehicle report 104, 204 in response to the incident 12, which may be detected by the monitoring system 120, 220. The vehicle report 104, 204 is generated by the vehicle processor 102, 202 gathering the impact data 152, 252 from the monitoring system 120, 220. While the impact data 152, 252 is described above with respect to the sensor array 140, 240, it is also contemplated that the impact data 152, 252 may also include the in-cabin image data 126, 226 in addition to the external image data 132, 232.

According to the illustrated example in FIG. 1, the external image data 132 of the first vehicle 100 may depict the forward portion 228 of the second vehicle 200 making contact with the rearward portion 130 of the first vehicle 100. The first vehicle processor 102 may gather the external image data 132 depicting the contact between the first vehicle 100 and the second vehicle 200 and include the external image data 132 as part of the first vehicle report 104. It is also contemplated that a series of images of the external image data 132 may be collectively utilized by the vehicle processor 102, 202 to depict a series of events related to the incident 12.

The second vehicle processor 202 is also configured to gather the second vehicle impact data 252 from the perspective of the second vehicle 200. As described in detail below, it is contemplated that the server 300 is configured to identify whether the first impact data 152 matches the second vehicle impact data 252. If the first vehicle impact data 152 is inconsistent with the second vehicle impact data 252, then the server 300 may determine that the impact event 18 of the first vehicle 100 is different from the impact event 18 of the second vehicle 200. Inconsistent impact data 152, 252 may occur when multiple incidents 12 occur in a localized area and/or within the predetermined radius 16, such that multiple vehicle reports 104, 204 are transmitted to the server 300, even when the impact event 18 was a result of separate incidents 12. The server 300 is configured to identify and separate unrelated incidents 12 and generate the incident report 302 in response to the determination of the involved parties.

In some examples, the vehicle processors 102, 202 may utilize the impact data 152, 252 to identify a direction of impact 154, 254. As described below, the direction of impact 154, 254 determined by each of the vehicle processors 102, 202 may be evaluated by the server 300 to determine an impact direction 20 as used in the incident report 302. While both of the vehicle processors 102, 202 may identify a direction of impact 154, 254, it is contemplated that the identified direction of impact 154, 254 may be inconsistent if the impact event 18 of the vehicles 100, 200 is unrelated. Thus, the server processor 304, discussed below; is configured to identify whether impact event 18 of the first vehicle 100 matches the impact event 18 of the second vehicle 200 by comparing, at least in part, the identified directions of impact 154, 254.

With further reference to FIGS. 2-5, the server 300 is equipped with the server processor 304 and is configured as a cloud-based data system. The server 300 communicates with the vehicles 100, 200 via wireless communication including, but not limited to, Bluetooth®, ultra-wideband, cellular networks, or any other practicable wireless communication network. It is also contemplated that the first vehicle processor 102 and the second vehicle processor 202 may use similar wireless communication to transfer the respective vehicle profiles 106, 206. The server 300 is configured to receive and send data between the vehicle processors 102, 202 and third party processors 408 of the third party devices 402. For example, the first vehicle profile 106 and the second vehicle profile 206 are shared with the server 300 through wireless communication. While it is contemplated that the vehicle processors 102, 202 may exchange the respective vehicle profiles 106, 206 directly, it is also contemplated that the server 300 may be utilized to exchange the vehicle profiles 106, 206.

As mentioned above, the server 300 receives the vehicle reports 104, 204 from the respective vehicle processor 102, 202 and, via the server processor 304, generates the incident report 302, described below. As described herein, the server processor 304 executes the operations on the server 300, such that the operations described as being executed by the server 300 may be understood to be simultaneously executed by the server processor 304 and vice versa. The incident report 302 generated by the server 300 may be utilized by official personnel to assess the incident 12 independent of the occupants involved. For example, once the server processor 304 generates the incident report 302, the incident report 302 is sent to the relevant insurance company and police personnel for reporting. The server processor 304 may also include an incident log 306 that is configured to track and monitor reported incidents 12 and store the incident report 302 and track future incident reports 302 corresponding to vehicle profiles. For example, after the sever processor 304 generates the incident report 302, the involved vehicles 100, 200 may be recorded in the incident log 306 stored on the server processor 304. If one or both of the vehicles 100, 200 are already registered on the incident log 306, then an incident event 308 will be added to the incident log 306 associated with the respective vehicle 100, 200.

The incident log 306 may additionally or alternatively be configured to log a location 310 of the incident 12. By logging the incident location 310, the server 300 may determine or otherwise identify a location 310 where incidents 12 may frequently occur. Thus, the incident evaluation system 10 may advantageously assist official personnel in evaluating locations with a high rate of incidents. The data compiled by the incident log 306 may assist in deciding various adjustments and/or potential revisions to minimize future incidents at the identified location(s).

Referring still to FIGS. 2-5 and as mentioned above, the server 300 may also query one or more third party devices 402 to collect the third party data 400 stored in a respective third party processor 408. In some examples, the third parties or third party devices 402 may include nearby vehicles, buildings, and other public or private surveillance systems. In some aspects, the third party devices 402 receive a notification from the server 300 indicating that the incident 12 occurred nearby and requesting the third party data 400 from the respective third party processor 408. The server 300, as described below, may utilize the collected third party data 400 in combination with the vehicle reports 104, 204 from the respective vehicle processors 102, 202 to generate the incident report 302.

For example, the server 300 may first compare the first vehicle report 104 with the second vehicle report 204 and identify whether the first vehicle 100 and the second vehicle 200 were involved in the same incident 12. The server 300 may evaluate the timestamp 150, 250 of the incident 12, recorded by each of the vehicle processors 102, 202. The server 300 also evaluates whether the location 310 of the incident 12 matches between the first vehicle report 104 and the second vehicle report 204. Further, the server 300 evaluates the impact data 152, 252 included in both of the vehicle reports 104, 204. The server 300 may determine, from the impact data 152, 252, an impact direction 20. While the server processor 304 is configured to compare the identified direction of impact 154, 254 from each of the vehicle processors 102, 202, it is contemplated that the server processor 304 may independently determine the impact direction 20 from the impact data 152, 252. The impact direction 20 is defined as the transfer of momentum from one vehicle 200 to another vehicle 100. For example, the impact direction 20 illustrated in FIG. 2 is from the second vehicle 200 to the first vehicle 100. Once the server processor 304 has evaluated the impact data 152, 252 and determined the impact direction 20, then the server processor 304 may compare the impact direction 20 with the identified directions of impact 154, 254.

If the server 300 determines that the impact direction 20 is consistent with the identified directions of impact 154, 254, then the server 300 may compare the external image data 132, 232. In some instances, the server processor 304 compares the image data 132 from the first imager 122 with the image data 232 from the second imager 222 to determine the impact direction 20. All of the data gathered from the vehicle processors 102, 202 by the server 300 may be compared with the third party data 400 to further evaluate the incident 12.

Ultimately, the server 300 may determine that the vehicles 100, 200 were involved in the same incident 12 and may exchange the respective vehicle profiles 106, 206 between the vehicle processors 102, 202. If the server 300 determines that the vehicles 100, 200 were involved, then the server 300 may generate the incident report 302 directed to and including both of the vehicle profiles 106, 206. In some examples, the server processor 304 is configured to receive the first vehicle insurance details 110 and the second vehicle insurance details 210 and is configured to exchange the first vehicle insurance details 110 with the driver 14a of the second vehicle 200 via the second vehicle processor 202. The server processor 304 may also exchange the second vehicle insurance details 210 with the driver 14a of the first vehicle 100 via the first vehicle processor 102. Alternatively, as mentioned above, the vehicle profiles 106, 206 may be exchanged directly between the vehicle processors 102, 202 prior to determination by the server 300.

In either aspect, the occupants 14 of the first vehicle 100 and the second vehicle 200 may obtain the vehicle profile 106, 206 of the other of the first vehicle 100 and the second vehicle 200 without face-to-face interaction. For example, the vehicle profile 106, 206 may be displayed on an infotainment device of the vehicle 100, 200 and/or may be transmitted by the respective receiving vehicle processor 102, 202 to the user device 404 of the driver 14a. In some incidents 12 it is advantageous to minimize interaction between and/or movement of occupants 14 after the incident 12. Wireless communication of the vehicle profiles 106, 206 assists in transferring the vehicle insurance details 110, 210 and occupant information 112, 212 with minimal interaction between the occupants 14.

With further reference to FIGS. 2-5, the impact event 18 is included as part of the incident report 302 generated by the server processor 304. As mentioned above, the incident report 302 may also include the external image data 132, 232, the in-cabin image data 126, 226, and the pre-incident image data 134, 234 from each of the vehicle reports 104, 204. The server processor 304 is configured to analyze the external image data 132, 232 when determining the impact direction 20 and may also identify a time of impact. The server processor 304 may also compare the first impact data 152 gathered from the first sensor array 140 with the second impact data 252 gathered from the second sensor array 240 to determine when, for example, the second vehicle 200 was approaching the first vehicle 100 and within range of the first proximity sensor 142. The impact data 152, 252 pertaining to the capacitive sensor 144, 244 is used to determine a time of impact 24. In some examples, the server processor 304 may compare the timestamp 150, 250 recorded by each of the vehicle processors 102, 202 with the determined time of impact 24 and record any discrepancies as part of the incident report 302.

The server processor 304 may also receive a plurality of impact reports 410 from the third party devices 402 to evaluate the incident 12 and determine involvement of each of the first vehicle 100 and the second vehicle 200. In addition to determining the impact direction 20, the server processor 304 may determine an at-fault party based in part on the third party data 400. The server processor 304 may compare the respective impact data 152, 252 from each of the first vehicle processor 102 and the second vehicle processor 202 with the third party data 400) to confirm the impact direction 20 and evaluation the circumstances surrounding the incident 12.

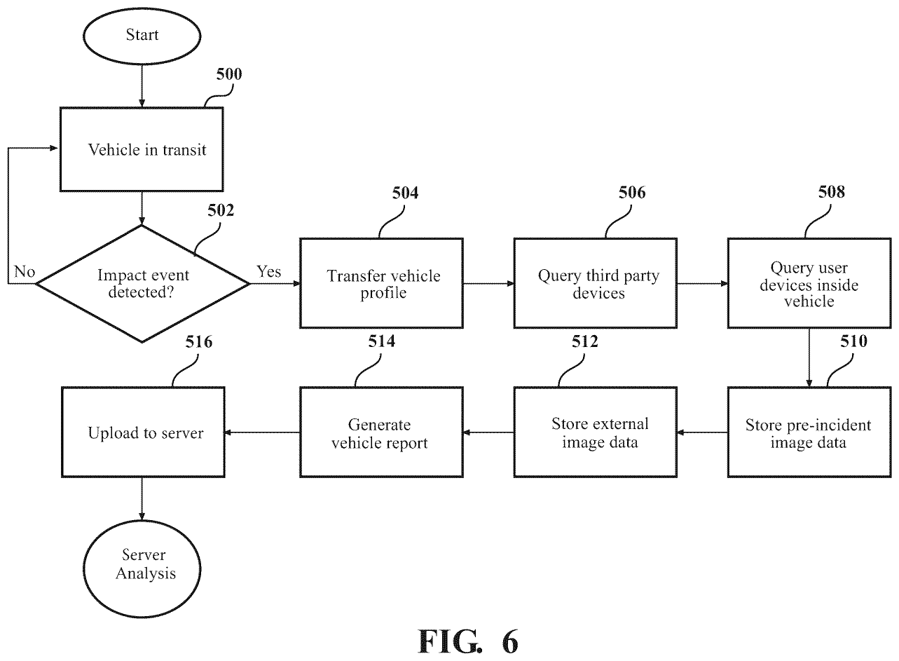

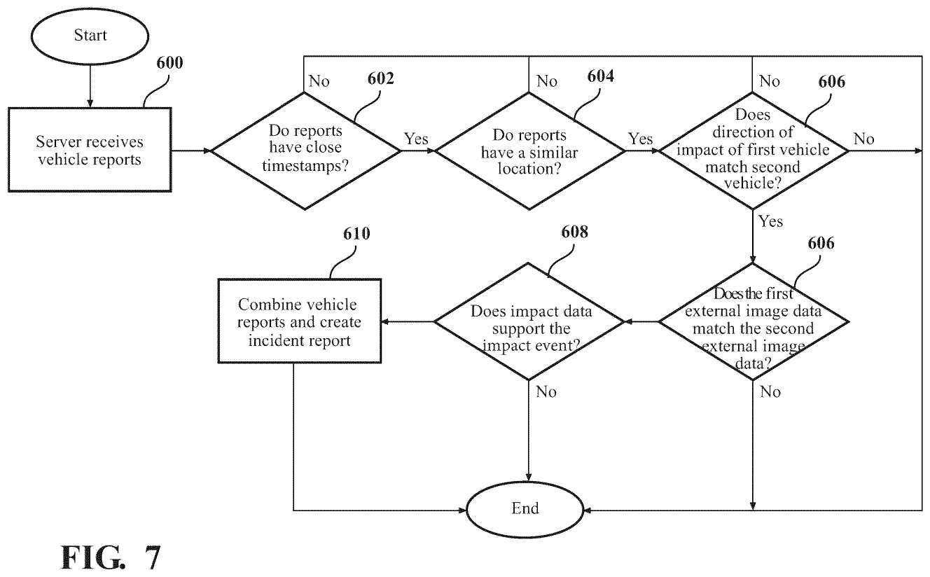

With reference now to FIGS. 6 and 7, an example flow diagram of operations of the vehicle incident evaluation system 10 is set forth. One or more vehicles 100, 200 may be in transit, at 500, and the vehicle processor 102, 202 monitors, at 502, whether an incident 12 has occurred. The vehicle processor 102, 202 continues to monitor the vehicle 100, 200 during transit until an incident 12 is detected. The vehicle processor 102, 202, at 504, may transfer the vehicle profile 106, 206 to the other vehicle processor 102, 202 and, at 506, the vehicle processor 102, 202 queries surrounding third party devices 402 within the predetermined radius 16 for respective vehicle profiles. The vehicle processor 102, 202 may also query, at 508, all user devices 404 within the respective vehicle 100, 200.

As mentioned above, the vehicle profiles 106, 206 may include pre-incident image data 134, 234. The vehicle processor 102, 202, at 710, stores the pre-incident image data 134, 234 and may include the pre-incident image data 134, 234 in the vehicle report 104, 204. The vehicle processor 102, 202 then, at 512, generates the vehicle report 104, 204 and, at 514, uploads the vehicle report 104, 204 to the server 300. The server 300 receives, at 600, the vehicle reports 104, 204 from the first vehicle processor 102 and the second vehicle processor 202, respectively. The server processor 304 evaluates the vehicle reports 104, 204 and determines, at 602, whether the time of impact 24 included in the first vehicle report 104 and the second vehicle report 204 matches the other of the first vehicle report 104 and the second vehicle report 204. If the time of impact 24 in the first vehicle report 104 does not match and/or is not within a predetermined timeframe then the server processor 304 determines that the first vehicle report 104 and the second vehicle report 204 are unrelated.

If the time of impact 24 of both vehicle reports 104, 204 is consistent, then the server processor 304, at 604, evaluates the proximity of the reported incident 12. For example, the server processor 304 compares the incident location in the first vehicle report 104 with the incident location in the second vehicle report 204. If the reported incidents 12 are not within the detection range 146, 246, then the server processor 304 determines that the reported incidents 12 are unrelated. If the reported incidents 12 are within the detection range 146, 246, then the server processor 304, at 606 determines whether the reported direction of impact 154, 254 of the first vehicle report 104 and the second vehicle report 204 matches the other of the first vehicle report 104 and the second vehicle report 204. If the reported directions of impact 154, 254 are inconsistent, then the server processor 304 determines that the reported incidents 12 are unrelated.

If the reported directions of impact 154, 254 are consistent between the vehicle reports 104, 204, then the server processor 304, at 608, compares the external image data 132, 232 from each of the vehicle reports 104, 204. The server processor 304, at 610, may also compare the impact data 152, 252 from the vehicle reports 104, 204 to determine whether the impact data 152, 252 supports the impact event 18 of the incident 12. If the impact data 152, 252 is consistent and supports the impact event 18 then the server 300, at 612, may combine the vehicle reports 104, 204 into a single incident report 302.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle incident evaluation system, comprising:
at least one imager configured to capture image data;
a first vehicle processor storing a first vehicle profile and configured to receive captured image data of a first vehicle from the imager and configured to generate a first vehicle report including the first vehicle profile and the captured image data in response to an impact event;
a second vehicle processor storing a second vehicle profile and configured to generate a second vehicle report including the second vehicle profile in response to the impact event; and
a server communicatively coupled to each of the first vehicle processor and the second vehicle processor and including a server processor configured to receive each of the first vehicle report and the second vehicle report and configured to generate an incident report and determine an impact direction based on comparison of the first vehicle report and the second vehicle report.

2. The vehicle incident evaluation system of claim 1, wherein the at least one imager includes a first imager coupled to the first vehicle and a second imager coupled to a second vehicle, the first vehicle processor configured to receive image data from the first imager and the second vehicle processor configured to receive image data from the second imager.

3. The vehicle incident evaluation system of claim 2, wherein the server processor is configured to compare the image data from the first imager with the image data from the second imager to determine the impact direction.

4. The vehicle incident evaluation system of claim 1, wherein the first vehicle profile includes first vehicle insurance details and the second vehicle profile includes second vehicle insurance details.

5. The vehicle incident evaluation system of claim 4, wherein the server processor is configured to receive the first vehicle insurance details and the second vehicle insurance details and is configured to exchange the first vehicle insurance details with a driver of a second vehicle via the second vehicle processor and exchange the second vehicle insurance details with a driver of the first vehicle via the first vehicle processor.

6. The vehicle incident evaluation system of claim 1, wherein the at least one imager is disposed within an interior cabin of one of the first vehicle and a second vehicle.

7. The vehicle incident evaluation system of claim 1, wherein the first vehicle processor and the second vehicle processor are each configured to gather data from one or more user devices within an interior cabin of the first vehicle and an interior cabin of a second vehicle, respectively.

8. An incident evaluation system for vehicle incidents, the incident evaluation system comprising:
a first imager configured to capture image data corresponding to a first vehicle;
a first vehicle processor communicatively coupled to the first imager and configured to receive the captured image data and generate a first vehicle report in response to an incident captured in the image data, the first vehicle processor including a first vehicle profile including at least one of first vehicle insurance details, driver details, and pre-incident image data; and
a server communicatively coupled to the first vehicle processor and configured to receive the first vehicle report and evaluate the captured image data to generate an incident report.

9. The incident evaluation system of claim 8, further including a second vehicle processor communicatively coupled to the server and including a second vehicle profile, the second vehicle processor configured to generate a second vehicle report in response to the incident.

10. The incident evaluation system of claim 9, further including a second imager configured to capture image data corresponding to a second vehicle, the server configured to compare the image data from the second vehicle processor with the image data from the first vehicle processor to identify an impact direction.

11. The incident evaluation system of claim 9, wherein the server is configured to query third party devices for third party data related to the incident.

12. The incident evaluation system of claim 11, wherein the server is configured to compare the third party data with the first vehicle report and the second vehicle report to determine an impact direction.

13. The incident evaluation system of claim 8, wherein the server is configured to receive a plurality of impact reports in addition to the first vehicle report and is configured to identify involved parties for each respective impact report including the first vehicle report.

14. The incident evaluation system of claim 8, wherein the server includes an incident log configured to store the incident report and track future incident reports corresponding to vehicle profiles including the first vehicle profile.

15. An incident evaluation system, comprising:
a first vehicle processor storing a first vehicle profile including first vehicle insurance details and configured to gather first vehicle impact data in response to a first impact event and to generate a first vehicle report including the first vehicle profile and the first vehicle impact data in response to the first impact event;
a second vehicle processor storing a second vehicle profile and configured to generate a second vehicle report including the second vehicle profile in response to the first impact event or to a second impact event different than the first impact event; and
a server communicatively coupled to each of the first vehicle processor and the second vehicle processor and configured to receive each of the first vehicle report and the second vehicle report and configured to generate an incident report and determine an impact direction based on comparison of the first vehicle report and the second vehicle report.

16. The incident evaluation system of claim 15, wherein the first vehicle impact data includes image data from a first imager coupled to one of a forward portion and a rearward portion of a first vehicle.

17. The incident evaluation system of claim 16, wherein the second vehicle processor is configured to gather second vehicle impact data from a second imager coupled to one of a forward portion and a rearward portion of a second vehicle.

18. The incident evaluation system of claim 17, wherein the server is configured to compare the first vehicle impact data with the second vehicle impact data to determine the impact direction.

19. The incident evaluation system of claim 15, wherein the server is configured to determine whether both the first vehicle report and the second vehicle report include the first impact event.

20. The incident evaluation system of claim 15, wherein the server is configured to query third party devices for third party data related to at least one of the first impact event and the second impact event.
